(19) United States
(12) Patent Application Publication
(10) Pub. No.: US 2014/0181492 A1
(43) Pub. Date: Jun. 26, 2014

(54) METHOD OF BOOTING AN ELECTRONIC SYSTEM AND AN ELECTRONIC SYSTEM APPLYING THE SAME

(71) Applicant: Ene Technology Inc., Hsin-Chu (TW)

(72) Inventors: Haru Chen, Hsin-Chu (TW); Su-Wu Lo, Hsin-Chu (TW)

(21) Appl. No.: 13/936,717

(22) Filed: Jul. 8, 2013

(30) Foreign Application Priority Data
Dec. 24, 2012 (TW) 101149556

(51) Int. Cl. G06F 9/44

(52) U.S. Cl. CPC G06F 9/4401
USPC 713/2

(57) ABSTRACT

In a method of booting an electronic system, a processor generates a booting request signal in response to an external control signal, and a memory controller enables the processor to read and execute a first boot program stored in a first memory in response to the booting request signal. The processor generates a booting success signal when booting using the first boot program is successful. The memory controller enables the processor to change, from reading and executing the first boot program stored in the first memory to reading and executing a second boot program stored in a second memory for booting of the electronic system, according to at least one of the booting request signal and the booting success signal.

### CROSS-REFERENCE TO RELATED APPLICATION

This application claims priority of Taiwanese application no. 101149556, filed on Dec. 24, 2012.

### BACKGROUND OF THE INVENTION

1. Field of the Invention

The present invention relates to a method of booting an electronic system and an electronic system applying the same.

2. Description of the Related Art

Commonly, an electronic system has to be successfully booted before applications can be executed. Examples of the electronic system include personal computers, cellular phones and personal digital assistant (PDA).

The conventional method of booting an electronic system requires a processor to read and execute a booting program from a flash memory. The electronic system requires the boot program to be functional in order for the system to be properly booted. However, when the flash memory is damaged or the programming code stored in the flash memory has errors, the processor may be unable to successfully boot the electronic system.

### SUMMARY OF THE INVENTION

The object of the present invention is to provide a method of booting an electronic system that provides a higher success rate of booting.

According to one aspect of the present invention, there is provided a method of booting an electronic system. The electronic system includes a first memory storing a first boot program, a second memory storing a second boot program, a processor, and a memory controller coupled to the first and second memories and the processor.

The method of this invention comprises the steps of:

a) in response to an external control signal, configuring the processor to generate a booting request signal;

b) in response to the booting request signal, configuring the memory controller to enable the processor to read and execute the first boot program stored in the first memory for booting of the electronic system;

c) configuring the processor to generate a booting success signal when booting of the electronic system using the first boot program is successful; and

d) configuring the memory controller to enable the processor to change, from reading and executing the first boot program stored in the first memory to reading and executing the second boot program stored in the second memory for booting of the electronic system, according to at least one of the booting request signal and the booting success signal.

Another object of the present invention is to provide an electronic system that applies the booting method of this invention.

According to another aspect of the present invention, an electronic system comprises:

a first memory storing a first boot program;

a second memory storing a second boot program;

a processor; and

a memory controller coupled to the first and second memories and the processor;

wherein the processor is configured, in response to an external control signal, to generate a booting request signal;

wherein the memory controller is configured, in response to the booting request signal, to enable the processor to read and execute the first boot program stored in the first memory for booting of the electronic system;

wherein the processor is configured to generate a booting success signal when booting of the electronic system using the first boot program is successful; and

wherein the memory controller is configured to enable the processor to change, from reading and executing the first boot program stored in the first memory to reading and executing the second boot program stored in the second memory for booting of the electronic system, according to at least one of the booting request signal and the booting success signal.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of an electronic system according to a first preferred embodiment of the present invention;

FIG. 2 is a flow chart of a booting method performed by the electronic system according to the first preferred embodiment of the present invention;

FIG. 3 is a timing diagram illustrating a first boot program being booted successfully in the first preferred embodiment of the present invention;

FIG. 4 is a timing diagram illustrating the first boot program being booted unsuccessfully in the first preferred embodiment of the present invention; and

FIG. 5 is a timing diagram illustrating the first boot program being booted unsuccessfully in a second preferred embodiment of the present invention.

### DETAILED DESCRIPTION OF THE PREFERRED EMBODIMENTS

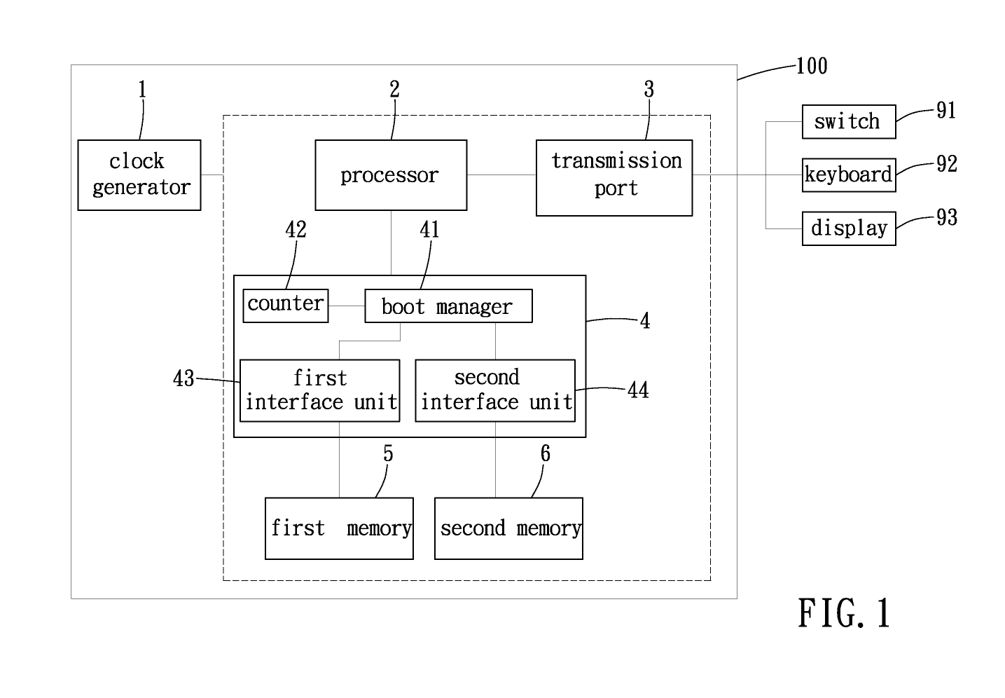

Referring to FIG. 1, a first preferred embodiment of an electronic system 100 of the present invention includes a clock generator 1, a processor 2, and a data transmission port 3 and a memory controller 4 that are electrically and respectively coupled with the processor 2. The electronic system 100 further includes a first memory 5 and a second memory 6 that are electrically and respectively coupled with the memory controller 4.

Preferably, the electronic system 100 is a computer, a cellular phone, personal digital assistant (PDA) or other bootable electronic system. The first memory 5 and the second memory 6 are implemented by using flash memory, but are not limited thereto. The first memory and the second memory 6 can also be Electrically-Erasable Programmable Read-Only Memory (EEPROM), or other forms of memory.

The data transmission port 3 is an input/output port (IC) port) of the electronic system 100. For instance, the data transmission port 3 can be an interface electrically coupled with at least an external power switch 91, a keyboard 92 and/or a display 93.

The first memory 5 stores a first boot program and many application programs and the second memory 6 stores a second boot program and many application programs. The clock generator 1 provides a clock signal for regulating the operations of the electronic system 100. The data transmission port 3 receives an external signal and sends the external signal to the processor 2. The processor 2 reads and executes the programs from the first memory 5 and the second memory 6 according to the external signal, and provides an output through the data transmission port 3. For instance, when the external power switch 91 is pressed, the processor 2 will read and execute booting boot program in response to the external signal, and the boot result will be displayed through the display 93.

Preferably, the processor 2 is controlled by the memory controller 4 to read the programs in the first memory 5 or the programs in the second memory 6. The memory controller 4 has a boot manager 41, a counter 42 electrically coupled with the boot manager 41, a first interface unit 43 and a second interface unit 44.

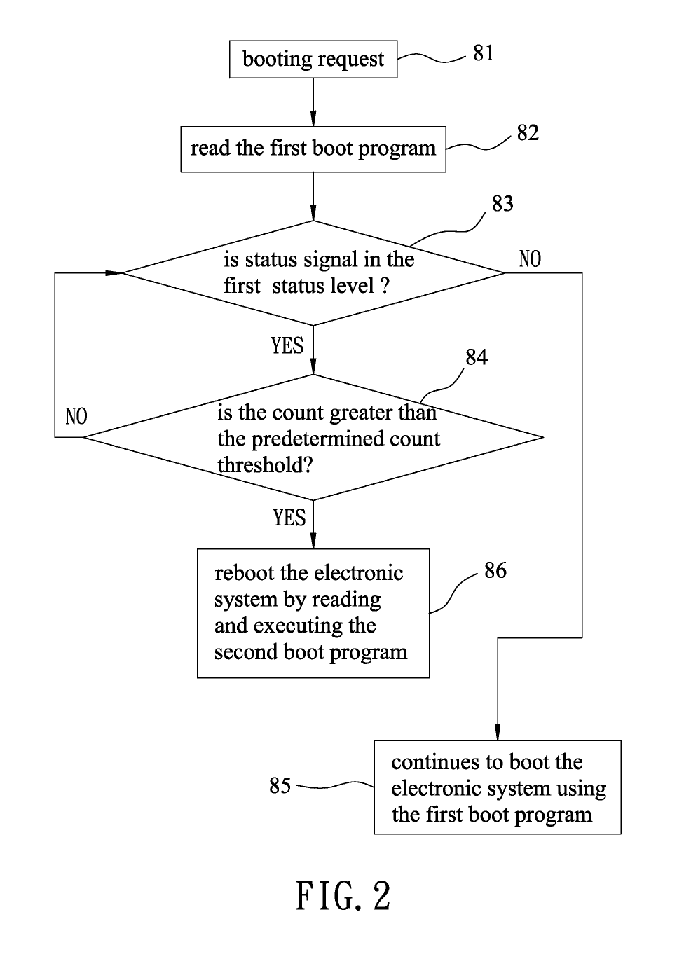

Referring to FIG. 2, an embodiment of a method of booting the electronic system 100 comprises the following steps:

Step 81: in response to an external control signal received from the data transmission port 3 and requesting initiation of a booting procedure, configuring the processor 2 to generate a booting request signal and send the booting request signal to the boot manager 41 through a data stream.

Step 82: in response to the booting request signal, configuring the memory controller 4 to switch a status signal from a first status level to a second status level different from the first status level and configuring the memory controller 4 to enable the processor 2 to read and execute the first boot program stored in the first memory 5 through the first interface unit 43 for booting of the electronic system 100.

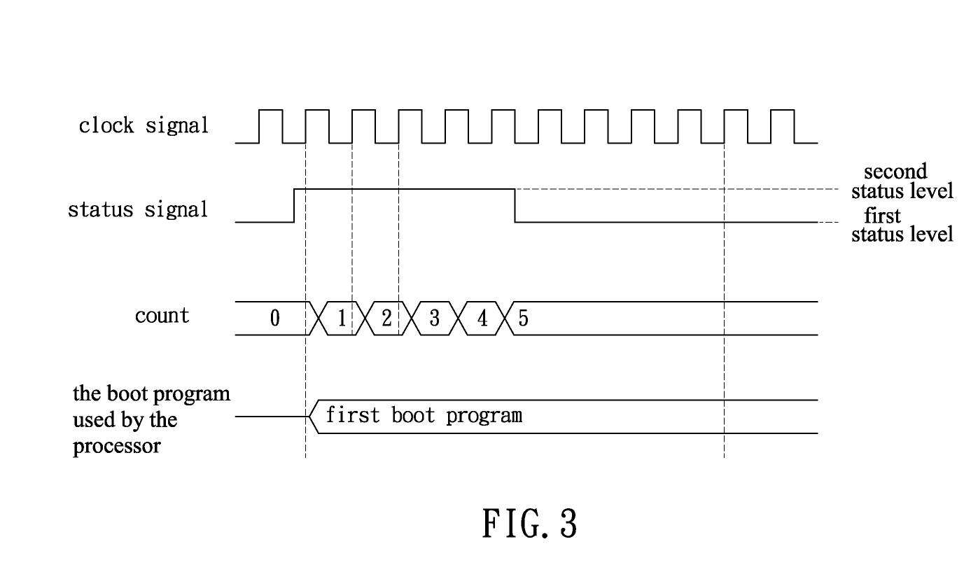

If the processor 2 executes the first boot program and successfully boots the electronic system 100, the processor 2 generates and sends a booting success signal into the data stream. Referring to FIG. 3, when the boot manager 41 detects the booting success signal from the data stream, the memory controller 4 is configured to switch the status signal from the second status level back to the first status level.

Step 83: configuring the counter 42 to count and the electronic system 100 to proceed to step 84 if the status signal is detected to be at the second status level during a rising edge of the clock signal, or configuring the counter 42 to stop counting and the electronic system 100 to proceed to step 85 if the status signal is not detected to be at the second status level during a rising edge of the clock signal.

Step 84: configuring the electronic system 100 to proceed to step 86 if the count is greater than a predetermined count threshold, or configuring the electronic system 100to proceed to step 83 if the count is not greater than a predetermined count threshold.

Steps 83 and 84 are performed on the same rising edge of the clock signal, while the next step 83 subsequent to the previous step 83, if any, is performed on the next rising edge of the clock signal.

Step 85: the processor 2 continues to boot the electronic system 100 using the first boot program.

Step 86: the boot manager 41 configuring the processor 2 to reboot the electronic system 100 by reading and executing the second boot program stored in the second memory 6 through the second interface unit 44.

Assuming the predetermined count threshold is eight and referring to FIG. 3, when the boot manager 41 detects that the status signal has the second status level during the preceding rising edge of the clock signal and that the status signal has the first status level with the current rising edge of the clock signal, the counter 42 stops count and the processor 2 maintains booting of the electronic system 100 using the first boot program.

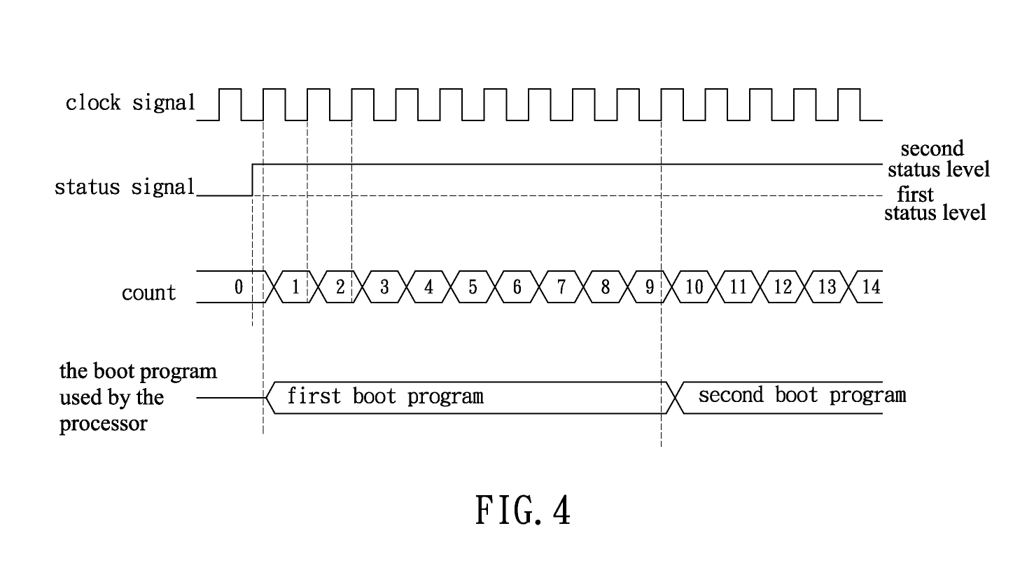

Referring to FIG. 4, when the boot manager 41 detects that the status signal has the second status level during the preceding rising edge of the clock signal and on the current rising edge of the clock signal and that the count is greater than eight (the predetermined count threshold), the processor 2 is configured to read and execute the second boot program stored in the second memory 6 to reboot the electronic system 100 and the counter 42 continues counting on the rising edges of the clock signal.

Therefore, the method of the first preferred embodiment can choose to boot the electronic system 100 using the second boot program when booting cannot be done using the first boot program. In contrast, a conventional booting method of an electronic system cannot recover from a boot failure when a boot program in a flash memory is faulty. Therefore, the method of the first preferred embodiment has a higher success rate in booting up the electronic system 100.

If the first boot program can be successfully booted, this preferred embodiment will boot with the first boot program to achieve a short booting time. On the other hand, if the first boot program cannot be successfully booted, the electronic system 100 can promptly switch to booting with the second boot program.

The first memory 5 is the default memory that the processor 2 relies on when it receives a booting request signal. The second memory 6 is the backup memory that is to be used by the processor 2 when the first boot program in the first memory 5 cannot be successfully booted. Storage quality and space, read or write speed, user preferences and other characteristics are the criteria for choosing a suitable memory for the first memory 5.

If the storage quality and space of the first memory 5 are better than those of the second memory 6 and in the event that the processor 2 boots using the second boot program in the second memory 6 after failing to boot using the first boot program in the first memory 5, the processor 2 may copy the second boot program to the first memory 5 as a replacement for the first boot program and the memory controller 4 will thereafter configure the processor 2 to reboot the electronic system 100 using the new first program stored in the first memory 5. Therefore, the processor 2 can more reliably and speedily boot from a functional boot program stored in a memory of a better quality.

In this preferred embodiment, the first status level is lower than the second status level. However, any configuration that has a difference in level can be recognized by the counter 42, and therefore many configurations are possible. The timing in which the counter 42 increases the count is not limited to only the rising edge of the clock signal, and counting on the falling edges of the clock signal is possible. It can also be with reference to both rising and falling edges of the clock signal, or with reference to a specific voltage level of the clock pulse.

The processor 2 uses a register for the data stream which has multiple addresses and associated data. For example, 0x24 represent an address that stores the boot request data. In the boot request data, 1 represents that a booting is requested, and 0 represents that no booting is requested. For example, 0x26 represents an address that stores booting success data. In the booting success data, 1 represents that the booting is successful, and 0 represents that the booting is unsuccessful. It is also possible that the processor 2 may directly send the boot request signal and the booting success signal to the boot manager 41 without storing and sending a data stream.

In summary, in the first preferred embodiment, the processor 2, in response to the booting request signal, boots the electronic system 100 using the first boot program. The boot manager 41 configures the status signal to be in the second status level, and the counter 42 initiates the count operation. When the count is greater than the predetermined count threshold during the current rising edge of the clock signal, the boot manager 41 configures the processor 2 to boot the electronic system 100 according to the second boot program. The status signal is maintained at the second status level, and the counter 42 increases the count on the current and each subsequent rising edge of the clock signal.

If the boot manager 41 detects the booting success signal only after the count is greater than the predetermined count threshold, the processor 2 will still boot according to the second boot program. On the other hand, if the boot manager 41 detects the booting success signal when the count is less than the predetermined count threshold, the boot manager 41 will switch the status signal from the second status level to the first status level. The counter 42 will stop the count on the next rising edge of the clock signal, and the processor 2 is configured to continue booting according to the first boot program.

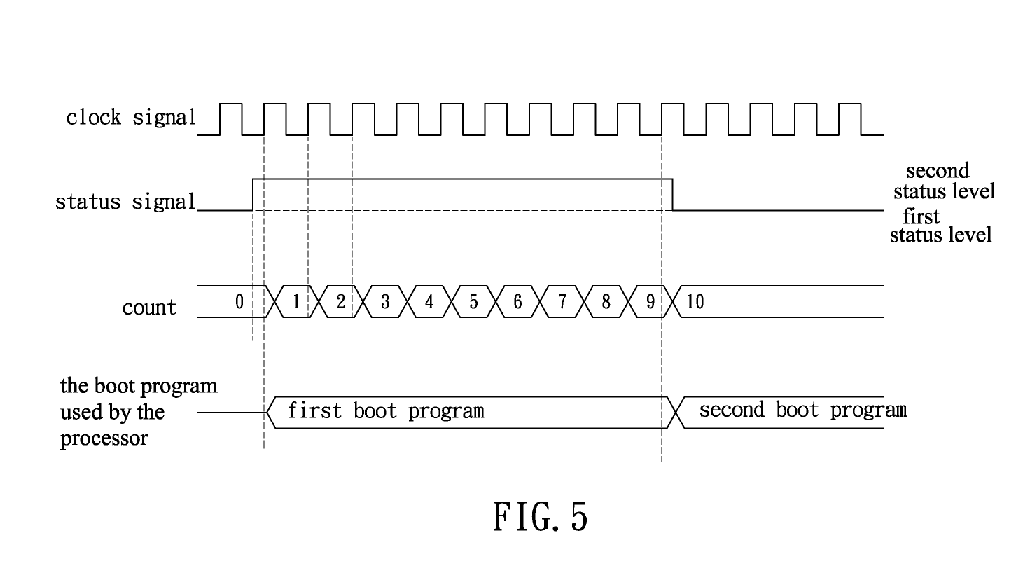

Referring to FIG. 5, the second preferred embodiment differs from the first preferred embodiment in terms of the following: When the count is greater than the predetermined count threshold during the rising edge of the clock signal, the boot manager 41 configures the processor 2 to boot the electronic system 100 according to the second boot program and switches the status signal from the second status level to the first status level. The counter 42 will stop the count on the next rising edge of the clock signal.

The electronic system 100 includes a first memory 5 and a second memory 6. However, at least one of the memories 5, 6 may be a separate component that is independent of the electronic system 100. The electronic system 100 may cooperate with more memories that respectively store boot programs to further improve the rate of booting success.

As described above, the counter 42 increases the count by 1 on each rising edge of the clock signal. However, in other applications, the increase can be of an other value. The counter 42 can also decrease the count, and in step 84, determine whether the count is smaller than a predetermined count threshold.

As described above, when the boot manager 41 detects the booting success signal, the boot manager 41 will switch the status signal from the second status level to the first status level. However, in other applications, the processor instead of the boot manager 41 will switch the status signal from the second status level to the first status level.

In summary, in the event that the first boot program cannot be successfully booted, the processor 2 will respond swiftly to boot from the second boot program, effectively reducing the time required for booting the electronic system 100. As long as one of the first and second boot programs is functional, the electronic system 100 can be successfully booted, and therefore the electronic system 100 has a higher successful rate of booting compared to conventional systems.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of booting an electronic system, the electronic system including a first memory storing a first boot program, a second memory storing a second boot program, a processor, and a memory controller coupled to the first and second memories and the processor, the method comprising the steps of:
a) in response to an external control signal, configuring the processor to generate a booting request signal;
b) in response to the booting request signal, configuring the memory controller to enable the processor to read and execute the first boot program stored in the first memory for booting of the electronic system;
c) configuring the processor to generate a booting success signal when booting of the electronic system using the first boot program is successful; and
d) configuring the memory controller to enable the processor to change, from reading and executing the first boot program stored in the first memory to reading and executing the second boot program stored in the second memory for booting of the electronic system, according to at least one of the booting request signal and the booting success signal.

2. The method as claimed in claim 1, wherein:
step b) includes configuring the memory controller to initiate a count operation; and
step d) includes configuring the memory controller to enable the processor to change from reading and executing the first boot program stored in the first memory to reading and executing the second boot program stored in the second memory based on a comparison result between a count value of the count operation and a predetermined count threshold.

3. The method as claimed in claim 2, wherein:
in step b), the memory controller is configured to switch a status signal from a first status level to a second status level different from the first status level in response to the booting request signal;
in step c), the memory controller is configured to switch the status signal from the second status level back to the first status level in response to the booting success signal, and to stop the count operation upon switching of the status signal back to the first status level; and
in step d), the memory controller is configured to enable the processor to change from reading and executing the first boot program stored in the first memory to reading and executing the second boot program stored in the second memory when the comparison result between the count value of the count operation and the predetermined count threshold indicates that an allowable boot time has elapsed without receipt of the booting success signal from the processor.

4. The method as claimed in claim 3, wherein:
in step c), the memory controller is further configured to switch the status signal from the second status level back to the first status level when the comparison result between the count value of the count operation and the predetermined count threshold indicates that the allowable boot time has elapsed without receipt of the booting success signal from the processor.

5. The method as claimed in claim 2, wherein:
in step c), the memory controller is configured to stop the count operation when the booting success signal is received from the processor and the comparison result between the count value of the count operation and the predetermined count threshold indicates that the booting success signal is received within an allowable boot time.

6. The method as claimed in claim 1, further comprising the following steps:
e) upon successful booting of the electronic system using the second boot program, configuring the processor to update the first boot program stored in the first memory using the second boot program; and
f) configuring the memory controller to enable the processor to reboot the electronic system based on the first boot program thus updated and stored in the first memory.

7. An electronic system comprising:
a first memory storing a first boot program;
a second memory storing a second boot program;
a processor; and
a memory controller coupled to said first and second memories and said processor;
wherein said processor is configured, in response to an external control signal, to generate a booting request signal;
wherein said memory controller is configured, in response to the booting request signal, to enable said processor to read and execute the first boot program stored in said first memory for booting of the electronic system;
wherein said processor is configured to generate a booting success signal when booting of the electronic system using the first boot program is successful; and
wherein said memory controller is configured to enable said processor to change, from reading and executing the first boot program stored in said first memory to reading and executing the second boot program stored in said second memory for booting of the electronic system, according to at least one of the booting request signal and the booting success signal.

8. The electronic system as claimed in claim 7, wherein said memory controller includes a counter that is configured to initiate a count operation in response to the booting request signal, and a boot manager that is configured to enable said processor to change from reading and executing the first boot program stored in said first memory to reading and executing the second boot program stored in said second memory based on a comparison result between a count value of the count operation and a predetermined count threshold.

9. The electronic system as claimed in claim 8, wherein:
said boot manager is configured to switch a status signal from a first status level to a second status level different from the first status level in response to the booting request signal, and to switch the status signal from the second status level back to the first status level in response to the booting success signal,
said counter is configured to stop the count operation upon switching of the status signal back to the first status level, and
said boot manager is further configured to enable said processor to change from reading and executing the first boot program stored in said first memory to reading and executing the second boot program stored in said second memory when the comparison result between the count value of the count operation and the predetermined count threshold indicates that an allowable boot time has elapsed without receipt of the booting success signal from said processor.

10. The electronic system as claimed in claim 9, wherein said boot manager is further configured to switch the status signal from the second status level back to the first status level when the comparison result between the count value of the count operation and the predetermined count threshold indicates that the allowable boot time has elapsed without receipt of the booting success signal from said processor.

11. The electronic system as claimed in claim 8, wherein said counter is configured to stop the count operation when the booting success signal is received from said processor and the comparison result between the count value of the count operation and the predetermined count threshold indicates that the booting success signal is received within an allowable boot time.

12. The electronic system as claimed in claim 7, wherein:
upon successful booting of the electronic system using the second boot program, said processor is configured to update the first boot program stored in said first memory using the second boot program, and said memory controller is configured to enable said processor to reboot the electronic system based on the first boot program thus updated and stored in said first memory.
